(19) United States
(12) Patent Application Publication
(10) Pub. No.: US 2009/0165943 A1
(43) Pub. Date: Jul. 2, 2009

(54) REDUCING MOIRE EFFECT IN AN LCD DEVICE COMPRISING A LIGHT CONTROL FILM

(76) Inventor: Ji-Hyung Kim, Suwon-City Kyonggi-Do (KR)

Correspondence Address: 3M INNOVATIVE PROPERTIES COMPANY, PO BOX 33427, ST. PAUL, MN, 55133-3427, US

(21) Appl. No.: 12/281,570

(22) PCT Filed: Feb. 16, 2007
(86) PCT No.: PCT/US2007/004013

§ 371 Date: Dec. 12, 2008

(30) Foreign Application Priority Data
Mar. 3, 2006 (KR) 1020060020616

(51) Int. Cl. G02F 1/1335; B32B 37/12

(52) U.S. Cl. 156/276

(57) ABSTRACT

The invention includes a method for reducing moire effect of an LCD device. An LCD device is provided comprising a liquid crystal panel having a front side and a back side. A light control film is placed on one side of the liquid crystal panel. The light control film comprises louver elements. A polarizer is placed on at least one side of the liquid crystal panel. At least one of the optical components placed on a front side of the liquid crystal panel is subjected to a haze treatment.

### BACKGROUND

The present invention relates to a method for reducing moiré effect exhibited in LCD devices that include a light control film comprising louver elements.

In general, an LCD device comprises a liquid crystal display panel (also referred to as a “liquid crystal panel”) and a light source, i.e. a backlight, which illuminates the liquid crystal panel from the back surface (i.e. the surface opposite of the display surface).

The typical LCD device also has a pair of first and second polarizers placed on either side of the liquid crystal panel. The polarizers are placed so that the polarization axes of the first polarizer and of the second polarizer (first and second polarization axes, respectively) form a certain angle, for example, a right angle. An example of the backlight is an edge-light type backlight, which comprises a light-guide plate and a light source that supplies light to the light-guide plate from the edge face of the plate. Instead of an edge-light type backlight, the backlight can be a direct-lit type backlight, wherein one or more light sources are placed behind the back surface of the liquid crystal panel within the output area of the display.

However, in the case of illumination by the above backlights, since the light beam is directly transmitted through the liquid crystal panel toward a viewer of the display and the display can be seen by a person standing at an angle apart from the viewer, guarding the privacy of the display is difficult, e.g., with an automated teller machine (ATM), the user's PIN number may be viewable by another person. Furthermore, when the LCD device is an automobile-loaded equipment, such as a car navigation system, the reflection from the panel of the LCD device on the windshield may interfere with the vision of the driver.

To solve these problems, the display panel can be equipped with a privacy filter that prevents the unnecessary propagation of light emitted by the liquid crystal panel in directions away from the viewing axis. One such privacy filter is a louver film having a plurality of minute louvers (or louver-form elements) inside. The louver film can be attached to the display screen to guard privacy and prevent unwanted reflections on vehicle windows. The plurality of minute louvers built into the louver film can control the propagation directions of the light beams that are transmitted through the louver film and set a specific exiting angle range (direction control effect). Thus, the emission of light beams that are transmitted through the liquid crystal panel in off-axis directions can be effectively prevented. Such a louver film is also a light control film.

However, when a light control film wherein the louver elements are regularly arranged is used in a LCD device, a moiré effect may be observed. The moiré effect results from the interference among two or more regular structures having different intrinsic frequencies For example, a moiré effect is observed as an interference phenomenon when two similar lattices are overlapped. Although the moiré effect is advantageously utilized in the field of measuring apparatuses and medical instruments, the moiré effect causes significant degradation in performance in display devices.

It is considered that the moiré effect occurs due to the interference among regularly arranged elements present in a liquid crystal panel, prismatic film, louver film and the like. Further, since LCD pixels have regular pitch structures, when optical conditioning films contain regularly repeated structures, avoiding moiré interference between the LCD pixels and the regular structures of an optical conditioning film is most difficult. In particular, when a film having regularly repeated louver elements, such as a light control film, is used in an LCD device, moiré interference with the LCD pixels is inevitable.

Therefore, methods for imparting non-uniformity to regularly arranged elements have been previously proposed. For example, a method for allowing the angles, sizes and arrangements of the elements of a prismatic film or a louver film to have irregular distributions was proposed. However, such methods have problems such as requiring complicated process to prepare devices having such non-uniformity and difficulty in creating elaborate displays.

### SUMMARY

The invention includes a method for reducing moiré effect of an LCD device. An LCD device is provided comprising a liquid crystal panel having a front side and a back side. A light control film is placed on one side of the liquid crystal panel. The light control film comprises louver elements. A polarizer is placed on at least one side of the liquid crystal panel. At least one of the optical components placed on a front side of the liquid crystal panel is subjected to a haze treatment.

### BRIEF DESCRIPTION OF THE DRAWINGS

FIG. 1 is a schematic view of a light control film comprising louver elements.

FIG. 2 is a schematic view representing the construction of an LCD device with a light control film.

FIG. 3 is a graphical view representing the luminance distribution of an LCD device subjected to a haze treatment of 80% and 25%.

FIG. 4 is a schematic view representing other embodiment of an LCD device comprising a light control film.

FIG. 5 is a schematic view representing another embodiment of an LCD device comprising a light control film.

In the figures, like reference numerals designate like elements.

### DETAILED DESCRIPTION

As described above, when a light control film comprising a louver layer is used in an LCD device, moiré interference with the LCD pixel pitch arises. Therefore, it is necessary to reduce the moiré effect.

The present invention relates to a method for reducing pixel moiré effect which can be exhibited in LCD devices comprising a light control film comprising louver elements. Specifically, the present invention relates to a method for reducing pixel moiré effect by use of a haze treatment applied to a layer or a film placed in front of a LCD device.

As mentioned earlier, a moiré effect is observed when a light control film with louver elements regularly arranged is used in a LCD display. In a LCD device, the moiré interference is particularly difficult to avoid when the optical conditioning film contains regularly repeated structures, since the LCD pixels have a regular pitch. In particular, when a film having regularly repeated louver elements, such as a light control film, is used in an LCD device, moiré interference with the LCD pixels is inevitable.

Previously, methods for imparting non-uniformity to regularly arranged elements, e.g., allowing irregular distributions of the angles, sizes and arrangements of the elements in a prismatic film or a louver film, have been proposed. However, such methods have problems such as requiring complicated process to prepare devices having such non-uniformity and difficulty in creating elaborate displays.

Thus, the present invention uses a haze treatment, which utilizes a simple process.

Since in fact countless big and small defects are present in a liquid crystal panel, though the liquid crystal panel is apparently considered as perfect, haze treatment has been previously used for protecting the defects. A haze treatment is also used to offset dim spots, which may appear all over the liquid crystal panel. In such cases, the haze treatment is usually applied to the rear polarizer of the liquid crystal panel.

In the present invention, however, applying the haze treatment to the rear polarizer is not effective, since the liquid crystal itself contains regularly repeated structures. Thus, in the present invention, the haze treatment is preferably applied to the front polarizer. When a polarizer is a multilayer laminated film, the haze treatment can comprise inserting beads into the adhesive layer used for attaching each polarizer film. Further, the haze treatment can be applied to a layer or film near the front polarizer, such as a protective film, substrate, a light control film, diffuser film, or an adhesive layer attaching such layer or film to the front polarizer.

Thus, we disclose herein a method for reducing pixel moiré effect of an LCD device comprising the step of: in the LCD device comprising a liquid crystal panel, a light control film comprising louver elements, and polarizer(s), wherein the light control film is placed on one side of the liquid crystal panel, and the polarizer(s) are placed on at least one side of the liquid crystal panel, subjecting an optical film placed on a front side of the liquid crystal panel to haze treatment. The optical film placed on the front side of the liquid crystal panel may be an optical conditioning film, such as a diffuser film, as well as a light control film and a polarizer.

In an LCD device where a light control film is placed on the front side of the liquid crystal panel, the haze treatment may be applied to the light control film. In this case, the haze treatment may be applied to a substrate, an adhesive layer, a protective film or an optical conditioning film, which is placed on or near the louver elements of the light control film.

The polarizer placed on the front side of the liquid crystal panel can be also subjected to the haze treatment. When the polarizer is a multilayer film where a substrate, an adhesive layer, a protective film or an optical conditioning film is further laminated to a polarizer film, the haze treatment may be applied to said substrate, adhesive layer, protective film or optical conditioning film.

The haze treatment can be performed by any methods known in the art, such as injecting beads formed of polystyrene, polymethacrylate or the like into a film. If the bead injection method is used, the degree of haze treatment can be controlled by the content of injected beads. Further, this degree is determined by measuring the extent of haze treatment of an optical film comprising an adhesive layer or a film layer to which the haze treatment is applied and by using a device such as Haze-gard Plus of BYK GARDNER. If the degree of haze treatment is too low, the moiré effect may not be sufficiently reduced, but if too high, the light transmittance of the LCD device may be significantly reduced. We have found that the amount of haze present at the front side of the liquid crystal panel is preferably from 40 to 80%, and more preferably 50 to 60%, in order to reduce the moiré effect without deteriorating the light transmittance of the LCD device. In this regard, the % haze refers to the percent haze as measured on a standard BYK GARDNER Haze-guard Plus instrument, or a similar measurement apparatus.

The constructions of the LCD device using a louver film and the embodiments of the haze treatment are described below.

The construction, manufacturing and application of louver films are specifically disclosed in U.S. Patent No. RE 27,617 (Olsen), U.S. Pat. No. 3,707,416 (Stevens) and U.S. Pat. No. 3,919,559 (Stevens).

FIG. 1 schematically represents a conventional light control film composite (10), which comprises a louver layer (12) containing louver elements (15) and rigid window substrates (14) fixed to both surfaces of the louver layer by adhesive layers. The louver layer (12) has minute louvers (or louver-form elements) (15) inside the film. In general, the louver layer (12) comprises light-transmitting parts (17) and minute louver elements (15), which shield light.

Preferably, he width or thickness of the light-transmitting part (17) between adjacent louver elements (15) is larger than the width or thickness of an individual louver element (15) (i.e., the dimension of the louver element in the direction parallel to the surface of the louver layer and perpendicular to the lengthwise direction of the louver element), so that the light transmittance of the light control film composite (10) as a whole does not significantly decrease. The angle (13) of the louver element, an angle between the surface of the louver layer and the plane of the louver element, is usually from 40 to 90 degrees. When the louver element lies at a right angle with the surface of the louver layer, the angle (13) of the louver element is 90 degrees. The pitch or spacing from one louver element to another, which spacing may or may not be uniform across the louver layer (12), is identified in FIG. 1 as item (11).

The light-transmitting parts (17) of the louver layer (12) are preferably made of a polymer having a high transparency. For example, a thermoplastic resin, a thermosetting resin, or a resin curable with an actinic ray such as UV ray may be used. Examples of such resins include cellulose resins (e.g. cellulose acetate butyrate and triacetylcellulose), polyolefin resins (e.g. polyethylene and polypropylene), polyester resins (e.g. polyethylene terephthalate), polystyrene, polyurethane, polyvinyl chloride, acrylic resins, and polycarbonate resins.

The louver elements (15) may be formed from a light-shielding material, which can absorb or reflect light. Examples of such a materials include (1) dark pigments or dark dyes, such as black or gray pigments or dyes, (2) metal, such as aluminum, silver, etc., (3) dark metal oxides, and (4) the above-described polymers containing dark pigments or dyes. The adhesive layer (16) may be formed of a conventional adhesive, such as a pressure-sensitive adhesive, a heat-sensitive adhesive, or a curable adhesive.

The two window substrates (14) fixed to the louver layer (12) preferably suppress the warp or curl of the louver layer (12) and in turn the warp or curl of the film composite (10) comprising the louver layer (12), and the surface side substrate also functions as a protective layer to protect the louver layer (12) from damage.

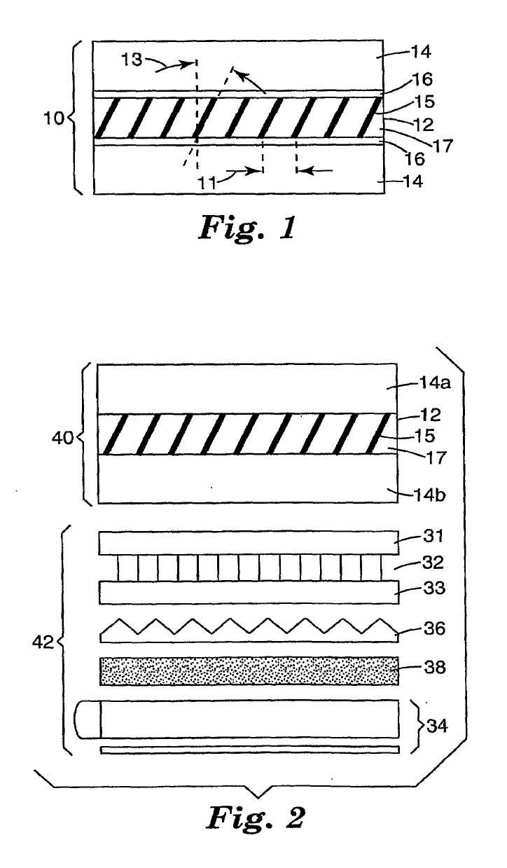

In a construction with an actual LCD device, such as the construction shown in FIG. 2, a light control film composite (40) is positioned in front of a display unit of an LCD device (42). Light control film composite (40) includes a louver layer (12) as described above and a front and back window substrate (14a), (14b) respectively, the window substrates preferably providing the composite (40) with sufficient stiffness to prevent warping or curling. In some cases, in order to provide added functionality in a thin profile, one or both window substrates can be replaced with an optical conditioning film, such as an absorbing polarizer, a reflective polarizer, a prismatic film or a diffuser film.

The absorbing polarizer may be a plane polarizer or a circular polarizer. A plane polarizer absorbs light of one polarization orientation more strongly than the light of the orthogonal polarization orientation. Examples of plane polarizers include a dichromic polarizer such as an H-type (iodine) polarizer and a dyestuff polarizer, an intrinsic polarizer such as a K-type polarizer and an improved K-type polarizer (referred to as a KE polarizer as manufactured by 3M Company, Norwood, Mass.), and a thinly cladded or encapsulated polarizer.

A circular polarizer blocks one of left-handed (L) or right-handed (R) circularly polarized light and transmits light of the other polarization state, and may be constructed of a plane polarizer and a quarter-wavelength retarder.

A reflective polarizer may act as a brightness enhancing component by reflecting light of undesired polarization back into the light chamber for recycling. The reflective polarizer only transmits light of the desired polarization and reflects light of undesired polarization. The reflected light may reenter the light chamber, potentially be converted to the desired polarization, and then later pass through the reflective polarizer. In this manner, light from the light source can be used more efficiently. An example of a suitable reflective polarizer is Vikuiti™ brand Dual Brightness Enhancing Film (DBEF) available from 3M Company.

The construction of FIG. 2 also includes LCD device (42). This LCD device (42) is illustrated as including a display unit comprising a front polarizer (31), a liquid crystal panel (32) and a rear polarizer (33), and a backlight unit (34). The display unit may comprise a front polarizer (31) and a liquid crystal panel (32) only. The illustrated LCD device (42) may further include a diffuser film (38) and a prismatic film (36) disposed between the display unit and backlight unit. In this embodiment, a haze treatment is applied to the substrate close to a user.

The prismatic film (36) may redirect light exiting the light chamber at particular angles relative to the prismatic film. The light redirected by the prismatic film (36) can also be recycled, eventually exiting the light chamber at an angle that will pass through the prismatic film. For example, Vikuiti™ brand Brightness Enhancing Film (BEF), available from 3M Company, could be used as the prismatic film (36). Alternatively, the prismatic film (36) may comprise Vikuiti™ brand Transmissive Right Angle Film (TRAF), also available from 3M Company. The TRAF redirects light coming in at high angles to exit at different angles.

The diffuser film (38) diffuses incoming light so that the intensity of the light is more spatially uniform. Light coming from one or more point sources may be much more intense at particular locations on an incident face of the diffuser film. Light that exits the diffuser film, however, will be more uniform in intensity across the exit surface of the diffuser film.

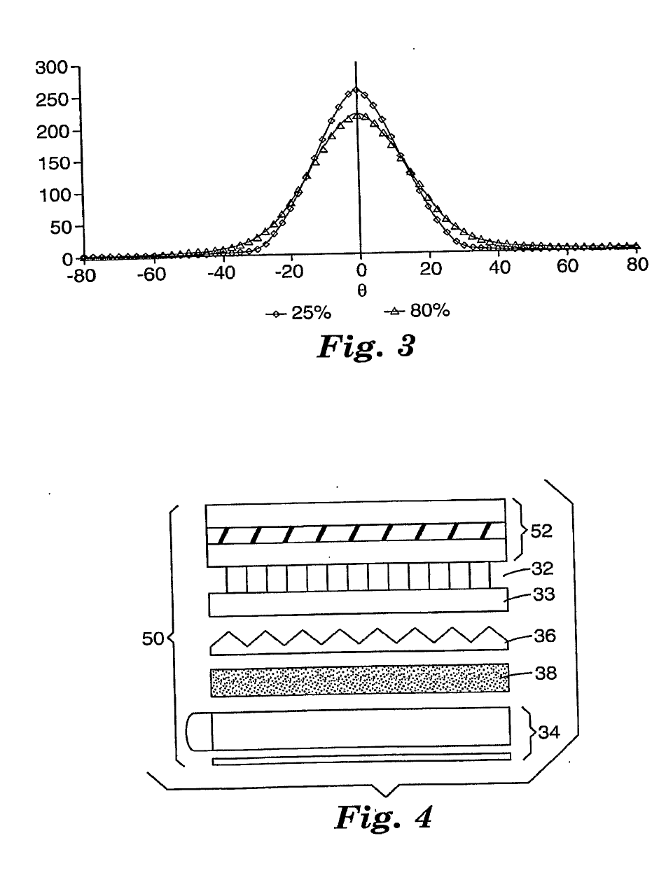

FIG. 3 is a chart showing the measured luminance distribution of an LCD device subjected to a haze treatment of 25% and 80%. In the chart, the average luminance (averaged over the output area of the LCD device) in units of nit is plotted as a function of the observation angle θ relative to the surface normal direction, with θ ranging from −80 to +80 degrees. The LCD device used has the same construction as the LCD device of FIG. 5 specifically described below and the haze treatment was applied to adhesive layers in the polarizer placed on the front side of the liquid crystal panel by inserting beads. Visual observations of this LCD device with 25% haze, 80% haze, and other haze values have also been made to study the effect of % haze on the performance of the system, including luminance and moiré effects.

In connection with these tests and observations, when the LCD device was subjected to a haze treatment of 25%, the elaborateness of the LCD device was decreased and the moiré effect could be observed in the display screen. However, when the LCD device was subjected to a haze treatment of 40%, although the moiré effect was slightly noticeable, viewer discomfort was significantly reduced compared to the 25% treatment. Further, when a haze treatment of 50% was applied, the moiré effect became barely noticeable. When a haze treatment of 80% was applied, the luminance of the LCD device became less than that of a 25% haze system but it exhibited a similar luminance distribution within the viewing angle range of interest. However, when the haze treatment of over 80% was applied, the moiré effect could not be observed but the light transmittance in the range of the viewing angle became significantly deteriorated.

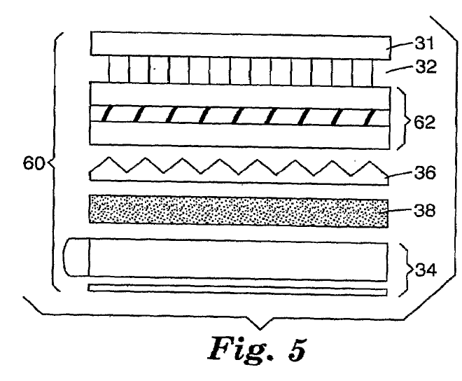

FIG. 4 schematically illustrates a construction of an LCD device (50) with a light control film composite (52) in front of a liquid crystal panel (32). The light control film here comprises a louver layer and an absorbing polarizer laminated to the rear surface of the louver layer. When the light control film composite (52) is used, a separate polarizer in front of the liquid crystal panel is unnecessary. A haze treatment may be applied to a substrate, a protective film or an optical conditioning film, which can be laminated to the front surface of the louver layer of the light control film composite (52).

FIG. 5 schematically illustrates a construction of an LCD device (60) with a light control film composite (62) in the rear of a liquid crystal panel. The light control film composite (62) comprises a louver layer, and an absorbing polarizer and a reflective polarizer laminated to the front and rear surfaces of the louver layer, respectively. As needed, a light control film composite laminated with a prismatic film or a diffuser film may be used instead of a reflective polarizer. In this embodiment, the absorbing polarizer (31) placed in the front surface of the liquid crystal panel may be subjected to a haze treatment. When other optical conditioning film or a protective film is placed onto the absorbing polarizer (31), the haze treatment may be applied to the layer or film close to a user.

While the invention has been described with respect to illustrative examples above, various modifications may be made without departing from the spirit and scope of the present invention as defined by the appended claims.

### Effect of the Invention

The present invention provides a method for simply reducing the moiré effect that arises when the light control film used, while maintaining the properties such as controlling the viewing angle and the like. As a result, the performance of the display does not decrease, unnecessary propagation of light from the liquid crystal panel is prevented, and the privacy of a user is guarded.

What is claimed is:

1. A method for reducing moiré effect of an LCD device comprising the steps of:
providing an LCD device comprising a liquid crystal panel having a front side and a back side;
placing a light control film on one side of the liquid crystal panel, the light control film comprising louver elements;
placing polarizer(s) on at least one side of the liquid crystal panel; and
subjecting at least one of the optical components placed on a front side of the liquid crystal panel to a haze treatment.

2. The method as recited in claim 1, wherein the light control film is placed on the front side of the liquid crystal panel and subjected to the haze treatment.

3. The method as recited in claim 2, further including placing a substrate, an adhesive layer, a protective film or an optical conditioning film on the louver elements of the light control film, and wherein said substrate, adhesive layer, protective film, or optical conditioning film is subjected to the haze treatment.

4. The method as recited in claim 1, wherein the placing polarizer(s) step includes placing a front polarizer on the front side of the liquid crystal panel, the front polarizer being subjected to the haze treatment.

5. The method as recited in claim 4, wherein the front polarizer includes a substrate, an adhesive layer, a protective film or an optical conditioning film, and wherein said substrate, adhesive layer, protective film or optical conditioning film is subjected to the haze treatment.

6. The method as recited in any one of claims 1 to 5, wherein the haze treatment is applied from 40% to 80%.

7. The method as recited in any one of claims 1 to 5, wherein the haze treatment is applied from 50% to 60%.
